(19) United States
(12) Patent Application Publication
(10) Pub. No.: US 2010/0138917 A1
(43) Pub. Date: Jun. 3, 2010

(54) REFRESH MECHANISM FOR RATE-BASED STATISTICS

(76) Inventors: Zhanhong XIA, Beijing (CN); Ping CHEN, Beijing (CN); Yunhui GAN, Beijing (CN)

Correspondence Address: O2MICRO INC;C/O MURABITO, HAO & BARNES LLP, TWO NORTH MARKET STREET, THIRD FLOOR, SAN JOSE, CA, 95113, US

(21) Appl. No.: 12/325,720

(22) Filed: Dec. 1, 2008

(51) Int. Cl. G06F 21/00

(52) U.S. Cl. 726/22

(57) ABSTRACT

Rate-based statistics are aperiodically refreshed. For example, for each Internet Protocol address being monitored, a time stamp of the last (most recent) statistics object (e.g., packet) and corresponding rate-based statistics are stored. The time stamp of a new statistics object is compared with the stored time stamp. The stored time stamp may be updated, and the stored statistics may be updated or refreshed, depending on the result of the comparison.

### TECHNICAL FIELD

Embodiments of the invention relate to a refresh mechanism for rate-based statistics.

### BACKGROUND ART

A denial-of-service (DOS) attack or distributed denial-of-service (DDOS) attack is an attempt to make a computer resource unavailable to its intended users. The symptoms of a DOS/DDOS attack include unusually slow network performance, unavailability of a particular Web site, inability to access any Web site, and a dramatic increase in the number of spam emails received.

Targets of DOS/DDOS attacks are typically sites or services hosted on high-profile Web servers such as bank servers, credit card payment gateways, and Domain Name System (DNS) root servers. A typical method employed in a DOS/DDOS attack is to saturate the target with external communication requests, typically a large number of packets directed to the target.

One anti-DOS/anti-DDOS mechanism currently used in network security apparatuses is to measure rate-based statistics for packets that are sent from the same Internet Protocol (IP) address and compare the rate-based statistics to a threshold value. The rate-based statistics are typically expressed as a function of time, such as bytes per second (BPS), packets per second (PPS), and session buildup rate (SR). If the rate-based statistics exceed the threshold value, then the packets are identified as being part of a DOS/DDOS attack and a network security apparatus will block the packets.

More specifically, a statistic used for indicating, for example, PPS for a particular source IP address is stored in memory such as DDR SDRAM (double data rate, synchronous dynamic random access memory), increased by one (1) when a packet with the particular source IP address is received, and compared against a threshold value as just described. Each second, the PPS statistic is refreshed and a new measurement is started.

Thus, the stored statistics are updated/refreshed every second. As noted above, rate-based statistics are stored per IP address in the DDR SDRAM. A very large number of IP addresses may be monitored, and so there may be a very large quantity of stored rate-based statistics. Consequently, updating/refreshing the statistics in the DDR SDRAM every second is time-consuming, and also consumes the bandwidth of the DDR SDRAM.

### SUMMARY

Embodiments of the present invention provide a new mechanism for refreshing rate-based statistics. In one embodiment, rate-based statistics are aperiodically refreshed. In one such embodiment, for each IP address being monitored, the time stamp of the last (most recent) statistics object (e.g., packet) and corresponding rate-based statistics are stored. The time stamp of a new statistics object is compared with the stored time stamp. The stored time stamp may be updated, and the stored statistics may be updated or refreshed, depending on the result of the comparison. Accordingly, refresh time and burdens on the memory are decreased.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 is a block diagram of a system for refreshing rate-based statistics according to one embodiment of the present invention.

FIG. 2 is diagram showing a method of refreshing rate-based statistics of a statistics object according to one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “storing,” “comparing,” “identifying,” “determining,” “updating,” “incrementing,” “refreshing,” “measuring,” “sending,” “starting,” “adding” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

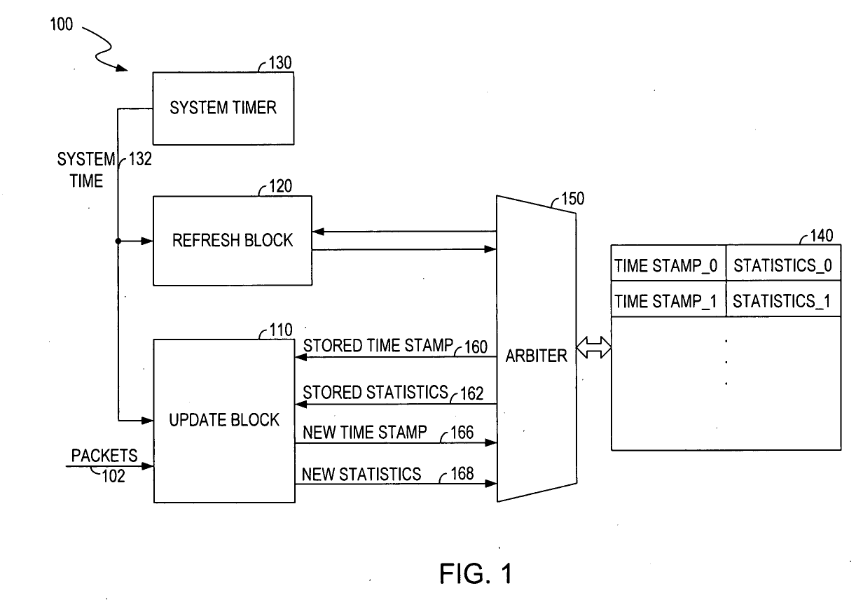

FIG. 1 illustrates a system 100 for refreshing rate-based statistics used in anti-DOS/anti-DDOS according to one embodiment of the present invention. The system 100 includes an update block 110, a refresh block 120, a system timer 130, a memory (e.g., DDR SDRAM) 140 and an arbiter 150. The arbiter 150 is coupled between the refresh block 120, the update block 110 and the memory 140 and serves as a data pathway. The update block 110 may also be referred to as a statistics updater and the refresh block 120 may also be referred to as a statistics refresher.

In FIG. 1, a single block may be described as performing a function or functions; however, in actual practice, the function or functions performed by that block may be performed in a single component or across multiple components, and/or may be performed using hardware, using software, or using a combination of hardware and software. Also, the system 100 may include components other than those shown, including well-known components such as a processor.

Packets 102 are input into the update block 110. An individual packet can be identified as being a member of a group of packets (e.g., a group of packets that may be part of a DOS/DDOS attack) in some manner. In one embodiment, the source IP address included in each packet is used to identify packets that are members of the same group. Each packet in the packets 102 is analyzed before coming into the update block 110, and thus the source IP address carried in each packet and other information such as the number of bytes in the packet are known to the update block 110.

Time stamps and statistics are stored in the memory 140. The statistics are sorted by source IP address; that is, for each source IP address being monitored, there is an associated set of statistics. In the example of FIG. 1, time stamp_0 and statistics_0 correspond to a first IP address, and time stamp_1 and statistics_1 correspond to a second IP address.

The system timer 130 provides a system time 132 to the refresh block 120 and the update block 110. In general, a time stamp based on the system time 132 is applied to each packet at the same point in the system 100. For example, the system time 132 can be used to indicate the time that a packet enters the update block 110. In one embodiment, the system timer 130 is an n-bit timer which starts at zero (0) and increases by a count of 1 every second. In such an embodiment, packets that arrive within each 1-second interval will receive the same time stamp.

In order to measure rate-based statistics for a plurality of packets that are sent from the same IP address, the time stamp of the last (most recent) packet received from that IP address and statistics (e.g., BPS, PPS and/or SR) associated with that time stamp and IP address are stored in the memory 140, in one embodiment. The update block 110 updates the time stamps and the statistics stored in the memory 140 in the manner described below. In one embodiment, the refresh block 120 periodically refreshes the statistics and updates the time stamps stored in the memory 140—more specifically, as described in further detail below, the refresh block automatically updates time stamps and refreshes statistics when a specified time period expires. The update block 110 and the refresh block 120 refresh statistics by setting their respective values to a specified initializing value. When updating the time stamps, the update block 110 and the refresh block 120 set selected time stamps to the current system time 132.

When a new packet (referred to as packet N) in the packets 102 comes into the update block 110, the update block 110 uses the source IP address carried in that packet to locate and read the time stamp 160 and statistics 162 (e.g., BPS, PPS and/or SR) stored in memory 140 that are associated with that source IP address.

The time stamp 166 of the most recent packet N is the system time 132 when the packet N came into the update block 110. The stored time stamp 160 is the system time 132 when the packet N-1 came into the update block 110, where the packets N and N-1 have the same source IP address IP_N, and where packet N-1 is the last packet with that source IP address to have arrived at the system 100 (that is, packets N-1 and N are consecutive packets within the group of packets defined by source IP address IP_N). The source IP address IP_N is used to locate the stored time stamp 160 in the memory 140. The new time stamp 166 for packet N is compared with the stored time stamp 160. The purpose of the comparison is to determine whether the packet N and the last packet N-1 are in the same statistic-gathering (statistical) cycle or period; if the new time stamp 166 and the stored time stamp 160 are equal, then the packets N and N-1 fall into the same statistical period.

In one embodiment, each statistical period is 1 second in length. In such an embodiment, if the two time stamps 160 and 166 are equal, then the new packet N and the last packet N-1 came into the update block 110 within the same 1-second interval.

If the two time stamps 160 and 166 are equal, then the stored time stamp 160 in the memory is not updated, and new statistics 168 for IP address_N are obtained by adding the statistics for the new packet N to the stored statistics 162 for IP address IP_N. That is, for example, the statistics BPS, PPS and/or SR sorted by IP address_N are incremented to account for the new packet N.

If, on the other hand, the two time stamps 160 and 166 are not equal, then the new packet N came into the update block 110 more than a second after the last packet N-1 (that is, packet N and packet N-1 do not fall within the same statistical period). Accordingly, the stored time stamp 160 is set to the new time stamp 166 of the new packet and the stored statistics 162 are refreshed (e.g., set to an initializing value). For example, PPS or SR can be set to an initializing value of 1, and BPS could be set to the packet length (bytes) of the current incoming packet.

Therefore, the time stamps and statistics in the memory 140 associated with a particular source IP address are not necessarily updated/refreshed each second. Instead, the time stamps and statistics associated with the particular source IP address are updated/refreshed aperiodically (at irregular intervals), depending on when a packet associated with that particular source IP address is received. In other words, updates/refreshes are event-driven instead of time-driven. Consequently, updating time is reduced, and so is the burden on the bandwidth of the anti-DOS/anti-DDOS mechanisms.

In one embodiment, in addition to the event-driven (aperiodic) refreshes just described, the refresh block 120 periodically updates the time stamps and refreshes the statistics in the memory 140 for selected source IP addresses to prevent an error that may otherwise occur if no packets with those IP addresses enter the update block 110 for a relatively long time. For example, as mentioned above, the system timer 130 may be an n-bit timer which starts at 0 and increases by a count of 1 every second; thus, the system timer 130 will reset to 0 at the (2ⁿ)th second. Assume, at the first second, a first packet P1 with a particular IP address IP_N1 comes into the update block 110 and is stamped with a time stamp of 0; thus, the update block 110 sends the new time stamp 166 (which is 0) to the memory 140 and updates the statistics in the memory 140 (e.g., the statistics are incremented and stored). Then, assume that no packets with the same IP address IP_N come into the update block 110 between the next second and the (2ⁿ)th second. At the (2ⁿ+1)th second, a second packet P2 with IP address IP_N1 (the same source address as packet P1) comes into the update block 110; the time stamp for this second packet would also be 0, even though the first and second packets are separated in real time by (2ⁿ+1) seconds. Because the two packets P1 and P2 have the same time stamp, the stored statistics for IP address IP_N would be updated as described above even though the two packets do not fall within the same statistical period unless a mechanism is included to prevent this from happening. Accordingly, in one embodiment, the refresh block 120 periodically and automatically updates the time stamps and refreshes the statistics when a specified refresh period expires. The automatic refresh period can be selected to be anywhere between 1 second and (2ⁿ−1) seconds.

More specifically, in one embodiment, at the end of the specified refresh period, the refresh block 120 reads the stored time stamp 160 for each IP address from the memory 140 and compares those time stamps with the system time 132 provided by the system timer 130. If the stored time stamp 160 for an IP address and the system time 132 are not equal, then the refresh block 120 updates the time stamp for that IP address in the memory 140 and also refreshes the stored statistics associated with that IP address. That is, at the end of each refresh period, for each IP address that has a time stamp that is different from the system time 132, the refresh block 120 sets the stored time stamp to the system time 132 and sets the stored statistics to their initializing value. If, at the end of each refresh period, the stored time stamp for an IP address and the system time are equal, then the stored statistics associated with that IP address are not updated.

With a shorter refresh period, the time stamps and statistics in the memory 140 are updated/refreshed more frequently. The refresh period can be chosen to be near to (2ⁿ−1) seconds in order to refresh less frequently.

The system 100 in FIG. 1 is not limited to anti-DOS/anti-DDOS applications and can be applied in other applications that refresh rate-based statistics.

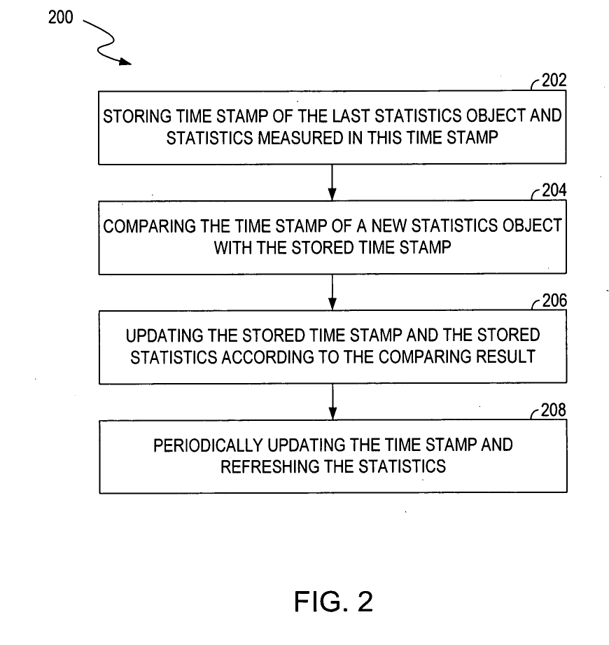

FIG. 2 is a flowchart 200 of a computer-implemented method for refreshing rate-based statistics of a “statistics object.” As used herein, a statistics object is an object that is accounted for using rate-based statistics. For example, packets that are sent from the same IP address constitute a statistics object. In one embodiment, the flowchart 200 is implemented as computer-executable instructions stored in a computer-readable medium. FIG. 2 is described in combination with FIG. 1. The discussion below pertains to packets that have the same source IP address; packets with other source IP addresses are treated in a parallel manner.

At 202, the time stamp of the last packet (packet N-1) that enters the update block 110, and the statistics associated with this time stamp (that is, the statistics accumulated during the time interval defined by the time stamp), are stored in the memory 140. The time stamp of a packet is the system time 132 provided by the system timer 130 when this packet enters the update block 110.

At 204, the time stamp of a new packet (packet N) is compared with the time stamp of the packet N-1 by the update block 110. More specifically, when the new packet N comes into the update block 110, the update block 110 reads the stored time stamp 160, which is the time stamp of the packet N-1 from the memory 140, and compares the time stamp of this new packet N with the stored time stamp 160.

At 206, the time stamp and the statistics in the memory 140 are updated/refreshed by the update block 110 based on the result of the time stamp comparison. If the comparison result is unequal, the new time stamp 166 (which is the time stamp of the new packet N) is sent to update the stored time stamp, and the stored statistics are refreshed to an initial value. If the comparison result is equal, the time stamp in the memory 140 is not updated but the stored statistics are updated (incremented).

At 208, the time stamp and the statistics in the memory 140 are periodically updated/refreshed by the refresh block 120, in order to eliminate an error that may otherwise be caused if no packet comes into the update block 110 for a relatively long period of time as previously described herein.

To summarize, in conventional applications, rate-based statistics are refreshed on a regular basis (every second, for example). In contrast, according to embodiments of the present invention, rate-based statistics are refreshed aperiodically: if a packet associated with those statistics is received during a statistical period (e.g., a 1-second period); if no such packet is received within that period of time, then the statistics are not refreshed (unless, in one embodiment, a specified refresh period is defined as previously described herein). In effect, counters associated with a source IP address are idle and keep their current values until either a packet with that source IP address is received or an automatic refresh period has expired. Accordingly, relative to conventional techniques, the number of refreshes is reduced (refreshes are performed less frequently), thereby reducing the loads on bandwidth and also reducing the amount of time spent performing the refreshes.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A system for refreshing rate-based statistics stored in a memory, said system comprising:
a timer for providing a time value that is used to time stamp each of a plurality of statistics object, wherein said statistics objects comprise a first object and a second object that are identified as members of the same group; and
a statistics updater coupled to said system timer and for aperiodically updating rate-based statistics associated with said group.

2. The system of claim 1 wherein said first object and said second object have the same source Internet Protocol (IP) address.

3. The system of claim 1 wherein said statistics for said group are updated only if a time stamp associated with said first object and a time stamp associated with said second object are the same.

4. The system of claim 1 wherein said statistics for said group are refreshed to an initializing value if a first time stamp associated with said first object and a second time stamp associated with said second object are different.

5. The system of claim 1 wherein said group also includes a third object that arrives at said system after first and second object, wherein said statistics for said group are updated to include statistics for said third object only if a time stamp associated with said statistics for said group and a time stamp associated with said third object are the same.

6. The system of claim 1 wherein said group also includes a third object that arrives at said system after first and second object, wherein said statistics for said group are refreshed to an initializing value if a value of a first time stamp associated with said statistics for said group and a value of a second time stamp associated with said third object are different; wherein further said value of said first time stamp is changed to said value of said second time stamp if said statistics for said group are refreshed.

7. The system of claim 1, further comprising a statistics refresher coupled to said statistics updater and for periodically refreshing said statistics in said memory in parallel with said statistics updater, wherein said statistics refresher refreshes said statistics in said memory when a predefined refresh period expires.

8. The system of claim 7 wherein said predefined refresh period is between one second and (2ⁿ−1) seconds if said timer is an n-bit timer.

9. A computer-implemented method of refreshing rate-based statistics stored in a memory, said method comprising:
accessing a value of a first time stamp corresponding to rate-based statistics associated with a group of statistics objects;
comparing a value of a second time stamp for a first statistics object to said value of said first time stamp, wherein said first statistics object is identified as being a related to said group; and
refreshing said statistics for said group to an initializing value if said value of said first time stamp and said value of said second time stamp are different and otherwise incrementing said statistics for said group.

10. The method of claim 9, further comprising changing said value of said first time stamp to equal said value of said second time stamp if said statistics for said group are refreshed to said initializing value.

11. The method of claim 9, further comprising:
accessing identifying information associated with said first statistics object; and
using said identifying information to locate said value of said first time stamp and said statistics for said group.

12. The method of claim 11 wherein said identifying information comprises a source Internet Protocol (IP) address.

13. The method of claim 9, further comprising automatically updating said statistics for said group when a predefined refresh period expires.

14. The method of claim 13, wherein said predefined refresh period is between 1 second and (2ⁿ−1) seconds using an n-bit timer.

15. A computer-implemented method of refreshing rate-based statistics stored in a memory, said method comprising:
identifying a first packet and a second packet that have the same source Internet Protocol (IP) address;
determining whether said first packet and said second packet are received during the same statistics-gathering period; and
incrementing rate-based statistics associated with said source IP address if both said first packet and said second packet are in said same statistics-gathering period and otherwise initializing said statistics associated with said source IP address.

16. The method of claim 15 wherein said determining comprises comparing a first time stamp associated with said first packet and a second time stamp associated with said second packet, wherein said first and second packets are both received during the same statistics-gathering period if said first and second time stamps are equal.

17. The method of claim 16 wherein, if said first and second time stamps are different, then said method further comprises associating the later of said first and second time stamps with said statistics associated with said source IP address.

18. The method of claim 16 wherein, if said first and second time stamps are equal, then said method further comprises associating the value of said first and second time stamps with said statistics associated with said source IP address.

19. The method of claim 15, further comprising automatically updating said statistics for said group when a predefined refresh period expires.

20. The method of claim 19 wherein said predefined refresh period is between 1 second and (2ⁿ−1) seconds using an n-bit timer.
